(19) United States
(12) Patent Application Publication
(10) Pub. No.: US 2011/0146726 A1
(43) Pub. Date: Jun. 23, 2011

(54) PROCESS FOR CLEANING SEMICONDUCTOR ELEMENT

(75) Inventors: Keiichi Tanaka, Tokyo (JP); Ryuji Sotoaka, Mie (JP)

(73) Assignee: Mitsubishi Gas Chemical Company, Inc., Tokyo (JP)

(21) Appl. No.: 12/995,303

(22) PCT Filed: May 20, 2009
(86) PCT No.: PCT/JP09/59280

§ 371 Date: Feb. 18, 2011

(30) Foreign Application Priority Data
Jun. 2, 2008 (JP) 2008-144534

(51) Int. Cl. B08B 3/00

(52) U.S. Cl. 134/28

(57) ABSTRACT

In a wiring formation process for a semiconductor device, the resist residue forming in dry etching with a reactive gas and aching with a plasma gas is removed, not corroding the members of the semiconductor device such as the interlayer insulating material and the wiring material thereof, and the device is protected from after-corrosion to occur after left for a given period of time after the treatment.

According to a method comprising (1) washing step with an aqueous solution containing hydrofluoric acid, (2) a washing step with a mixed solution of ammonia and hydrogen peroxide, and (3) a washing step with hydrogen peroxide water, the resist residue on the side wall of a metal wiring that comprises aluminium (Al) as the main ingredient thereof is removed, and occurrence of after-corrosion is prevented.

### TECHNICAL FIELD

The present invention relates to a washing method in a wiring formation process for a semiconductor device, in which the resist residue to remain on the side wall of wiring in wire processing by dry etching or the resist residue to remain in removal by ashing of a photoresist layer with a plasma gas is removed not corroding the members of the semiconductor device being processed such as the interlayer insulating material or the wiring material thereof, and in which after-corrosion to occur after the process can be prevented.

### BACKGROUND ART

Heretofore, to a process of formation of metal wiring of a semiconductor device that comprises aluminium (Al) as the main ingredient thereof, lithography technology is applied. Lithography technology is a microprocessing technique comprising applying a photoresist to the surface layer of a wiring material or an interlayer insulating material, then patterning it through photoexposure and development, and thereafter via the patterned photoresist layer serving as a mask, selectively etching the semiconductor device member in the non-masked area. For the etching, used is a chemical agent or a reactive gas, but use of a reactive gas is the mainstream of dry etching technology; and during selective etching according to such dry etching technology followed by ashing removal of photoresist with a plasma gas, a resist residue may remain on the side wall of Al wiring. In case where such a resist residue remains, it causes breaking of wire or wiring abnormality, and therefore must be completely removed.

For completely peeling away the resist residue, used is a wet removal method with a chemical liquid. As the residue peeling liquid composition for use in the wet removal method, for example, known is “a fluorine-based aqueous solution comprising a fluorine compound, a water-soluble organic solvent and an anticorrosive” (see Patent Reference 1 and Patent Reference 2); and as a multistage processing method using a peeling liquid composition, proposed is “a method of peeling with a fluorine compound-containing peeling liquid followed by washing with peroxide-containing water” (see Patent Reference 3). The peeling liquid is widely used as its residue peelability is good and its effect of preventing substrate corrosion is excellent; however, it is problematic in point of occurrence of after-corrosion (by oxidized foreign matter not forming just after washing treatment but forming on the side wall of Al wiring after left for a few hours after the treatment). Accordingly, a washing method is earnestly desired that satisfies both resist residue removability and after-corrosion preventability.

[Patent Reference 1] JP-A 7-201794

[Patent Reference 2] JP-A 8-202052

[Patent Reference 3] JP-A 9-213704

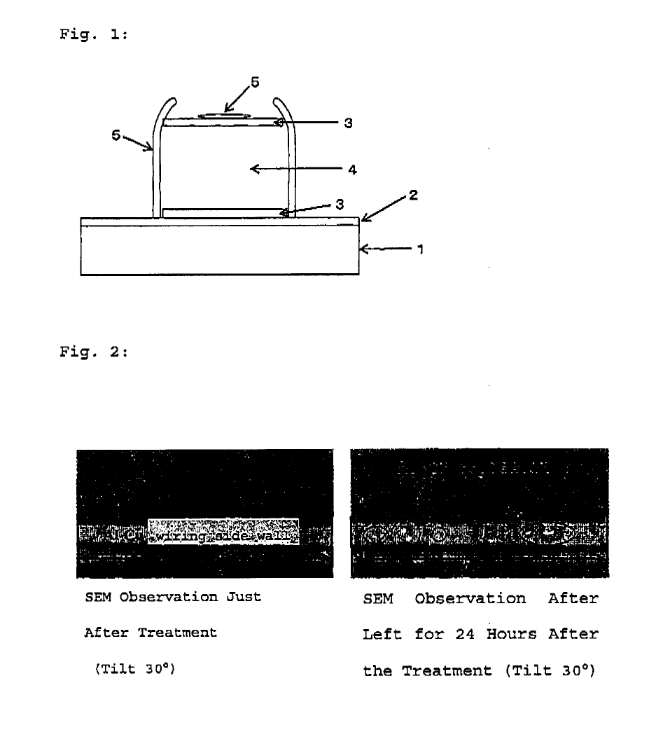

### BRIEF DESCRIPTION OF THE DRAWINGS

[FIG. 1] It is a cross-sectional view of an aluminium alloy circuit device produced by dry etching through a photoresist layer serving as a mask to form an aluminium-copper (Al—Cu) alloy wiring body 4 followed by removing the photoresist layer through asking.

[FIG. 2] It shows SEM photographs of aluminium-copper wiring just after washing treatment and after 24 hours.

### DESCRIPTION OF REFERENCE NUMERALS

1. Silicon substrate
2. Silicon oxide film
3. Titanium nitride layer
4. Aluminium-copper (Al—Cu) alloy
5. Resist residue

### DISCLOSURE OF THE INVENTION

### Problems that the Invention is to Solve

An object of the present invention is to provide a washing method for completely peeling away the resist residue remaining in processing metal wiring that comprises aluminium (Al) as the main ingredient thereof, by dry etching followed by plasma ashing, not corroding the members of the semiconductor device being processed such as the interlayer insulating material or the wiring material thereof but preventing occurrence of after-corrosion.

### Means for Solving the Problems

The present inventors have assiduously studied for the purpose of solving the above-mentioned problems and, as a result, have found that, according to a multistage washing method comprising washing with an aqueous solution containing hydrofluoric acid in the first stage, treating with a mixed aqueous solution of ammonia and hydrogen peroxide in the second stage and washing with hydrogen peroxide water in the third stage, the resist residue can be completely removed and occurrence of after-corrosion can be prevented.

Specifically, the present invention relates to a washing method for semiconductor devices, and its summary includes the following:

1. A method for washing and removing a resist residue on a semiconductor that remains on the side and the top of metal wiring in producing a semiconductor device containing a metal that comprises aluminium (Al) as the main ingredient thereof, after resist formation, dry etching and ashing, the semiconductor washing method comprising sequentially the following washing treatments (1) to (3):

(1) washing treatment with an aqueous solution containing hydrofluoric acid,
(2) washing treatment with a mixed solution of ammonia and hydrogen peroxide,
(3) washing treatment with hydrogen peroxide water.

2. The semiconductor device washing method of Item 1, wherein the aqueous solution containing hydrofluoric acid contains an organic phosphonic acid.

3. The semiconductor device washing method of Item 2, wherein the organic phosphonic acid is at least one selected from aminomethylphosphonic acid, hydroxyethylidene-1,1-diphosphonic acid, aminotrimethylenephosphonic acid, ethylenediamine-tetramethylenephosphonic acid, diethylenetriamine-pentamethylenephosphonic acid, hexamethylenediamine-tetramethylenephosphonic acid, bishexamethylenetriamine-pentamethylenephosphonic acid, and 1,2-propylenediamine-tetramethylenephosphonic acid.

4. The semiconductor device washing method of Item 1, wherein the concentration of hydrofluoric acid in the aqueous solution containing hydrofluoric acid is from 0.001 to 0.05% by weight.

5. The semiconductor device washing method of Item 2, wherein the concentration of the organic phosphoric acid in the aqueous solution containing hydrofluoric acid is from 0.005 to 1% by weight.

6. The semiconductor device washing method of Item 1, wherein the aqueous mixed solution of ammonia and hydrogen peroxide is a solution containing from 0.001 to 1% by weight of ammonia and from 0.1 to 30% by weight of hydrogen peroxide, and having a pH falling within a range of from 8 to 10.

7. The semiconductor device washing method of Item 1, wherein the hydrogen peroxide concentration in the hydrogen peroxide water is from 0.1 to 31% by weight.

### Advantage of the Invention

Use of the washing method of the present invention makes it possible to completely peel away the photoresist-derived residue remaining on the side wall of wiring of a metal that comprises aluminium (Al) as the main ingredient thereof, not corroding the members of the semiconductor device being processed such as the interlayer insulating material or the wiring material thereof but preventing occurrence of after-corrosion.

### BEST MODE FOR CARRYING OUT THE INVENTION

### (1) Washing Treatment with Aqueous Solution Containing Hydrofluoric Acid (First Stage)

In the washing treatment (1) with an aqueous solution containing hydrofluoric acid (hereinafter this may be simply referred to as the first stage) in the present invention, the hydrofluoric acid-containing aqueous solution to be used as the processing liquid is not specifically defined so far as it is an aqueous solution containing hydrofluoric acid, and it may be an aqueous solution of hydrofluoric acid alone, but preferably contains an organic phosphonic acid. Adding an organic phosphonic acid to the aqueous solution containing hydrofluoric acid may enhance the anticorrosion capability of the solution for the metal wiring material that comprises aluminium (Al) as the main ingredient thereof and may therefore enable more effective treatment.

As the organic phosphonic acid that may be in the aqueous hydrofluoric acid solution, preferred are aminomethylphosphonic acid, hydroxyethylidene-diphosphonic acid, aminotrimethylene-phosphonic acid, ethylenediamine-tetramethylenephosphonic acid, diethylenetriamine-pentamethylenephosphonic acid, hexamethylenediamine-tetramethylenephosphonic acid, bishexamethylenetriamine-pentamethylenephosphonic acid, and propylenediamine-tetramethylenephosphonic acid. More preferred are hydroxyethylidene-diphosphonic acid, aminotrimethylenephosphonic acid, ethylenediamine-tetramethylenephosphonic acid, diethylenetriamine-pentamethylenephosphonic acid, hexamethylenediamine-tetramethylenephosphonic acid, bishexamethylenetriamine-pentamethylenephosphonic acid, and propylenediamine-tetramethylenephosphonic acid. Even more preferred are aminotrimethylenephosphonic acid, ethylenediamine-tetramethylenephosphonic acid, diethylenetriamine-pentamethylenephosphonic acid, propylenediamine-tetramethylenephosphonic acid.

The hydrofluoric acid concentration in the aqueous solution containing hydrofluoric acid may be suitably selected depending on the intended metal wiring, but in general, it is preferably within a range of from 0.001 to 0.05% by weight. When the hydrofluoric acid concentration is at least 0.001% by weight, then it is favorable since the residue removability of the solution would not lower; and when at most 0.05% by weight, then it is favorable since the wiring material would hardly be corroded. For the same reasons, more preferably, the concentration is from 0.003 to 0.03% by weight, even more preferably from 0.007 to 0.02% by weight.

The amount of the organic phosphonic acid to be added to the hydrofluoric acid-containing aqueous solution is preferably within a range of from 0.005 to 1.0% by weight, more preferably from 0.01 to 0.5% by weight, even more preferably from 0.03 to 0.2% by weight. When the amount of the organic phosphonic acid is within the above range, then it is favorable since the anticorrosion capability of the solution for metal wiring materials could be higher and therefore the solution would enable more effective treatment thereby facilitating the processing time control in the first stage. In addition, it is advantageous from the economical viewpoint.

### (2) Washing Treatment with Mixed Solution of Ammonia and Hydrogen Peroxide (Second Stage)

In the washing treatment (2) with a mixed solution of ammonia and hydrogen peroxide (hereinafter this may be simply referred to as the second stage) in the present invention, the mixed solution of ammonia and hydrogen peroxide to be used as the processing liquid is prepared preferably by mixing from 0.001 to 1% by weight of ammonia and from 0.1 to 30% by weight of hydrogen peroxide within a pH range of from 8 to 10. When the pH of the mixed solution is at most 10, then it is favorable since the metal wiring material would hardly be corroded; and when the pH is at least 8, it is favorable since the residue removability of the solution would not lower.

More preferably, the concentration of ammonia in the mixed solution is from 0.01 to 0.2% by weight, and even more preferably from 0.03 to 0.1% by weight. More preferably, the concentration of hydrogen peroxide is from 1 to 20% by weight, even more preferably from 3 to 10% by weight.

### (3) Washing Treatment with Hydrogen Peroxide Water (Third Stage)

In the washing treatment (3) with hydrogen peroxide water (hereinafter this may be simply referred to as the third stage) in the present invention, the concentration of hydrogen peroxide in the hydrogen peroxide water to be used as the processing liquid is preferably from 0.1 to 31% by weight. When the concentration of hydrogen peroxide is at least 0.1% by weight, then it is favorable since after-corrosion would hardly occur; and when at most 31% by weight, then it is favorable since the solution would be more effective for preventing after-corrosion, and in addition, since the stability of the hydrogen peroxide water is bettered, the handlability thereof would be bettered. For the same reasons, more preferably, the concentration of hydrogen peroxide is from 1 to 31% by weight, more preferably from 3 to 31% by weight. In the present invention, for attaining the effect of preventing after-corrosion, it is important to carry out the washing treatment itself with hydrogen peroxide water irrespective of the level of the concentration of hydrogen peroxide. Accordingly, in the washing treatment in the third stage, generally used is hydrogen peroxide water having a hydrogen peroxide concentration of 5% by weight or so.

### [Multistage Washing Treatment]

The washing technology of the present invention relates to a multistage washing treatment method. The main object of the washing treatment (1) with an aqueous solution containing hydrofluoric acid in the first stage is to remove a resist residue, and the solution has a great effect for removing a resist residue, but has the property of corroding a metal wiring material that comprises aluminium (Al) as the main ingredient thereof. Accordingly, regarding the state after the first-stage treatment, desirably, the washing is such that a resist residue is kept remaining in some degree rather than the resist residue is completely removed, in order that the metal wiring material is not corroded by the first-stage treatment.

Of the washing treatment (2) with a mixed solution of ammonia and hydrogen peroxide in the second stage, the power to remove residue is small, but the possibility thereof to corrode metal wiring materials is small; and therefore the object of the treatment is to remove the residue left unremoved in the first-stage treatment. Accordingly, the treatment additionally satisfies the effect of preventing the occurrence of after-corrosion that has been a problem in residue removing treatment in a process of metal wiring that comprises Al as the main ingredient thereof.

The object of the washing treatment (3) with hydrogen peroxide water in the third stage is to prevent and inhibit after-corrosion, and the treatment can completely prevent the occurrence of after-corrosion that has been insufficient in the second-stage treatment.

In the multistage washing treatment of the invention, the processing liquid to be used in each stage has the property as described in the above, and therefore the sequence of treatment is important. Treatment in accordance with the above-mentioned sequence with the first-stage processing liquid, the second-stage processing liquid and the third-stage processing liquid brings about good washing removability and good prevention of after-corrosion; however, in case where the treatment sequence is made to differ from the above, then the intended result could not be attained. For example, in case where the treatment with hydrogen peroxide water is attained in the first stage or in the second stage, then the effect of preventing after-corrosion is not sufficient (see Comparative Example 3); and in case where the treatment sequence with an aqueous hydrofluoric acid solution and with ammonia/hydrogen peroxide mixed solution is reversed, then the resist residue removability worsens (see Comparative Example 4). Before and after the treatment (between the first-stage treatment and the second-stage treatment, between the second-state treatment and the third-stage treatment, etc.), for example, a liquid not having any influence on the wiring material such as ultra-pure water may be used as rinsing water.

The washing temperature in the multistage washing treatment in the present invention is preferably from 10° C. to 40° C., more preferably from 15° C. to 35° C., even more preferably from 20° C. to 30° C. The washing time with the processing liquid in the first to third stages may be suitably selected depending on the intended metal wiring and the concentration of the processing solution to be used, but is preferably from 1 second to 10 minutes or so, more preferably from 5 seconds to 5 minutes, even more preferably from 5 seconds to 2 minutes. When the washing time is at least 1 second, then the liquid substitution between the processing liquids may be sufficient; and when at most 10 minutes, then a sufficient washing effect can be attained efficiently.

The processing liquids for use in the present invention do not contain an organic solvent or the like, which is a characteristic feature of the invention. Accordingly, the washing waste from the washing method of the present invention does not require any special waste treatment, which is one advantage of the present invention.

### EXAMPLES

The present invention is described in more detail with reference to the following Examples and Comparative Examples; however, the present invention is not whatsoever restricted by these Examples.

### Examples 1 to 20, Comparative Examples 1 to 6

FIG. 1 shows a cross-sectional view of aluminium alloy wiring produced by dry etching through a photoresist layer serving as a mask to form an aluminium-alloy (Al—Cu) wiring 4 followed by removing the photoresist layer through ashing with a plasma gas. From the bottom of the drawing, there are formed a silicon substrate 1, a silicon oxide film 2, a titanium nitride layer 3 serving as a barrier layer, and an Al—Cu wiring layer 4, and on this, a titanium nitride layer is formed further as an upper layer. A resist residue 5 remains on the sidewall and the top of the Al—Cu wiring. The aluminium wiring was used as a sample for evaluation, and processed in a mode of sheet-fed washing treatment according to the treatment sequence with the compositional liquids as described in Table 1.

The residue removability, the material corrosion, and the after-corrosion preventing effect were evaluated by leaving the processed wafer in a clean room for 24 hours, and observing it through SEM (Hitachi's S-5500). The SEM observation condition was as follows: The sample was tilted at 30 degrees so that its side walls could be observed, and the size to give a viewing field width (in the lateral direction) of 10 μm was taken as one viewing field. An example of a SEM photograph under the washing treatment condition to cause after-corrosion is shown in FIG. 2 (one viewing field). After-corrosion (visually detectable foreign manner on the side wall, having a size of at most 1 μm) did not occur just after the treatment, but occurred after 24 hours. The results of SEM observation evaluation of Al—Cu wiring processed under different conditions are shown in Table 2. The criteria for evaluation are as follows:

### (Residue Removability)

The evaluation samples of Examples and Comparative Examples were evaluated through SEM observation according to the criteria mentioned below. Evaluation Rank C or more is on the acceptable level.

A: Resist residue was completely removed.

B: At least 99% of resist residue was removed.

C: From 90% to less than 99% of resist residue was removed.

D: From 70% to less than 90% of residue was removed. E: Less than 70% of resist residue was removed.

### (Material Corrosion)

The evaluation samples of Examples and Comparative Examples were evaluated through SEM observation according to the criteria mentioned below. Evaluation Rank C or more is on the acceptable level.

A: No material corrosion was seen at all.

B: Little material corrosion was seen.

C: Some material corrosion was seen.

D: Material corrosion was partly seen on the aluminium wiring sidewall.

E: The aluminium wiring was entirely roughened.

### (Effect of Preventing After-Corrosion)

The evaluation samples of Examples and Comparative Examples were evaluated through SEM observation according to the criteria mentioned below. Evaluation Rank C or more is on the acceptable level.

A: In 10 viewing fields, no after-corrosion was seen at all.

B: In 10 viewing fields, from 1 to 9 after-corrosion spots were seen.

C: In 10 viewing fields, from 10 to 19 after-corrosion spots were seen.

D: In 10 viewing fields, from 20 to 99 after-corrosion spots were seen.

E: In 10 viewing fields, 100 or more after-corrosion spots were seen.

TABLE 1

| | 1st-stage treatment | | 2nd-stage treatment | | | 3rd-stage treatment | |
|---|---|---|---|---|---|---|---|
| | liquid composition (wt %) | time | liquid composition (wt %) | pH | time | liquid composition (wt %) | time |
| Example 1 | 0.02 wt % HF | 15 sec | 0.1 wt % H2O2, | 9.7 | 30 sec | 31 wt % H2O2 | 30 sec |
| | | | 0.001 wt % NH3 mixed liquid | | | | |
| Example 2 | 0.02 wt % HF | 15 sec | 5 wt % H2O2, | 9.2 | 30 sec | 31 wt % H2O2 | 30 sec |
| | | | 0.05 wt % NH3 mixed liquid | | | | |
| Example 3 | 0.02 wt % HF | 15 sec | 30 wt % H2O2, | 8.8 | 30 sec | 31 wt % H2O2 | 30 sec |
| | | | 1 wt % NH3 mixed liquid | | | | |
| Example 4 | 0.02 wt % HF | 15 sec | 5 wt % H2O2, | 9.2 | 30 sec | 5 wt % H2O2 | 30 sec |
| | | | 0.05 wt % NH3 mixed liquid | | | | |
| Example 5 | 0.02 wt % HF | 15 sec | 30 wt % H2O2, | 8.8 | 30 sec | 0.1 wt % H2O2 | 30 sec |
| | | | 1 wt % NH3 mixed liquid | | | | |
| Example 6 | 0.02 wt % HF | 15 sec | 0.1 wt % H2O2, | 9.7 | 30 sec | 0.1 wt % H2O2 | 30 sec |
| | | | 0.001 wt % NH3 mixed liquid | | | | |
| Example 7 | 0.02 wt % HF | 15 sec | 1 wt % H2O2, | 10.2 | 30 sec | 5 wt % H2O2 | 30 sec |
| | | | 0.05 wt % NH3 mixed liquid | | | | |
| Example 8 | 0.02 wt % HF | 15 sec | 30 wt % H2O2, | 7.2 | 30 sec | 5 wt % H2O2 | 30 sec |
| | | | 0.05 wt % NH3 mixed liquid | | | | |
| Example 9 | 0.001 wt % HF | 60 sec | 5 wt % H2O2, | 9.2 | 30 sec | 5 wt % H2O2 | 30 sec |
| | | | 0.05 wt % NH3 mixed liquid | | | | |
| Example 10 | 0.1 wt % HF | 15 sec | 5 wt % H2O2, | 9.2 | 30 sec | 5 wt % H2O2 | 30 sec |
| | | | 0.05 wt % NH3 mixed liquid | | | | |
| Example 11 | 0.05 wt % HF, | 15 sec | 5 wt % H2O2, | 9.2 | 30 sec | 5 wt % H2O2 | 30 sec |
| | 0.1 wt % ATP mixed liquid | | 0.05 wt % NH3 mixed liquid | | | | |
| Example 12 | 0.05 wt % HF, | 30 sec | 5 wt % H2O2, | 9.2 | 30 sec | 5 wt % H2O2 | 30 sec |
| | 0.8 wt % ATP mixed liquid | | 0.05 wt % NH3 mixed liquid | | | | |
| Example 13 | 0.02 wt % HF, | 30 sec | 5 wt % H2O2, | 9.2 | 30 sec | 5 wt % H2O2 | 30 sec |
| | 0.1 wt % ATP mixed liquid | | 0.05 wt % NH3 mixed liquid | | | | |
| Example 14 | 0.02 wt % HF, | 30 sec | 5 wt % H2O2, | 9.2 | 30 sec | 5 wt % H2O2 | 30 sec |
| | 0.1 wt % AMP mixed liquid | | 0.05 wt % NH3 mixed liquid | | | | |
| Example 15 | 0.02 wt % HF, | 30 sec | 5 wt % H2O2, | 9.2 | 30 sec | 5 wt % H2O2 | 30 sec |
| | 0.1 wt % HEDP mixed liquid | | 0.05 wt % NH3 mixed liquid | | | | |
| Example 16 | 0.02 wt % HF, | 30 sec | 5 wt % H2O2, | 9.2 | 30 sec | 5 wt % H2O2 | 30 sec |
| | 0.1 wt % EDTP mixed liquid | | 0.05 wt % NH3 mixed liquid | | | | |
| Example 17 | 0.02 wt % HF, | 30 sec | 5 wt % H2O2, | 9.2 | 30 sec | 5 wt % H2O2 | 30 sec |
| | 0.1 wt % DTPP mixed liquid | | 0.05 wt % NH3 mixed liquid | | | | |
| Example 18 | 0.02 wt % HF, | 30 sec | 5 wt % H2O2, | 9.2 | 30 sec | 5 wt % H2O2 | 30 sec |
| | 0.1 wt % HDTP mixed liquid | | 0.05 wt % NH3 mixed liquid | | | | |
| Example 19 | 0.02 wt % HF, | 30 sec | 5 wt % H2O2, | 9.2 | 30 sec | 5 wt % H2O2 | 30 sec |
| | 0.1 wt % BHTPP mixed liquid | | 0.05 wt % NH3 mixed liquid | | | | |
| Example 20 | 0.02 wt % HF, | 30 sec | 5 wt % H2O2, | 9.2 | 30 sec | 5 wt % H2O2 | 30 sec |
| | 0.1 wt % PDTP mixed liquid | | 0.05 wt % NH3 mixed liquid | | | | |
| Comparative | 0.02 wt % HF | 15 sec | no | — | — | no | — |
| Example 1 | | | | | | | |
| Comparative | 0.02 wt % HF | 15 sec | 5 wt % H2O2, | 9.2 | 30 sec | no | — |
| Example 2 | | | 0.05 wt % NH3 mixed liquid | | | | |
| Comparative | 0.02 wt % HF | 15 sec | 5 wt % H2O2 | — | 30 sec | 5 wt % H2O2, 0.05 wt % NH3 | 30 sec |
| Example 3 | | | | | | mixed liquid | |
| Comparative | 5 wt % H2O2, | 30 sec | 0.02 wt % HF | — | 15 sec | 5 wt % H2O2 | 30 sec |
| Example 4 | 0.05 wt % NH3 mixed liquid | | | | | | |
| Comparative | 5 wt % H2O2 | 30 sec | 5 wt % H2O2, | 9.2 | 30 sec | 0.02 wt % HF | 15 sec |
| Example 5 | | | 0.05 wt % NH3 mixed liquid | | | | |
| Comparative | 5 wt % H2O2, | 30 sec | 5 wt % H2O2 | — | 30 sec | 0.02 wt % HF | 15 sec |
| Example 6 | 0.05 wt % NH3 mixed liquid | | | | | | |

TABLE 2

| | SEM Observation Evaluation | | |
|---|---|---|---|
| | Residue | Material | After-Corrosion |
| | Removability | Corrosion | Prevention |
| Example 1 | A | B | A |
| Example 2 | A | B | A |
| Example 3 | A | B | A |
| Example 4 | A | B | A |
| Example 5 | A | B | A |
| Example 6 | A | B | B |
| Example 7 | A | C | C |
| Example 8 | B | B | A |
| Example 9 | A | B | A |
| Example 10 | A | C | C |
| Example 11 | A | A | A |
| Example 12 | A | A | A |
| Example 13 | A | A | A |
| Example 14 | A | A | A |
| Example 15 | A | A | A |
| Example 16 | A | A | A |
| Example 17 | A | A | A |
| Example 18 | A | A | A |
| Example 19 | A | A | A |
| Example 20 | A | A | A |
| Comparative Example 1 | D | B | E |
| Comparative Example 2 | A | B | D |
| Comparative Example 3 | A | B | D |
| Comparative Example 4 | D | B | B |
| Comparative Example 5 | D | B | E |
| Comparative Example 6 | D | B | E |

### INDUSTRIAL APPLICABILITY

Use of the washing method of the present invention makes it possible to completely peel away the photoresist-derived residue remaining on the side wall of wiring of a metal that comprises aluminium (Al) as the main ingredient thereof, not corroding the members of the semiconductor device being processed such as the interlayer insulating material or the wiring material thereof but preventing occurrence of after-corrosion. Based on the characteristic feature, the washing method of the invention is favorably used in a wiring formation process for semiconductor devices.

1. A method for washing and removing a resist residue on a semiconductor that remains on the side and the top of metal wiring in producing a semiconductor device containing a metal that comprises aluminium (Al) as the main ingredient thereof, after resist formation, dry etching and ashing, the semiconductor washing method comprising sequentially the following washing treatments (1) to (3):
(1) washing treatment with an aqueous solution containing hydrofluoric acid,
(2) washing treatment with a mixed solution of ammonia and hydrogen peroxide,
(3) washing treatment with hydrogen peroxide water.

2. The semiconductor device washing method according to claim 1, wherein the aqueous solution containing hydrofluoric acid contains an organic phosphonic acid.

3. The semiconductor device washing method according to claim 2, wherein the organic phosphonic acid is at least one selected from aminomethylphosphonic acid, hydroxyethylidene-1,1-diphosphonic acid, aminotrimethylenephosphonic acid, ethylenediamine-tetramethylenephosphonic acid, diethylenetriamine-pentamethylenephosphonic acid, hexamethylenediamine-tetramethylenephosphonic acid, bishexamethylenetriamine-pentamethylenephosphonic acid, and 1,2-propylenediamine-tetramethylenephosphonic acid.

4. The semiconductor device washing method according to claim 1, wherein the concentration of hydrofluoric acid in the aqueous solution containing hydrofluoric acid is from 0.001 to 0.05% by weight.

5. The semiconductor device washing method according to claim 2, wherein the concentration of the organic phosphonic acid in the aqueous solution containing hydrofluoric acid is from 0.005 to 1% by weight.

6. The semiconductor device washing method according to claim 1, wherein, the aqueous mixed solution of ammonia and hydrogen peroxide is a solution containing from 0.001 to 1% by weight of ammonia and from 0.1 to 30% by weight of hydrogen peroxide, and having a pH falling within a range of from 8 to 10.

7. The semiconductor device washing method according to claim 1, wherein the hydrogen peroxide concentration in the hydrogen peroxide water is from 0.1 to 31% by weight.
